(19) United States
(12) Patent Application Publication
(10) Pub. No.: US 2018/0266509 A1
(43) Pub. Date: Sep. 20, 2018

(54) DAMPER BEARING COMPRISING A HOUSING AND COVER

(71) Applicant: BASF SE, Ludwigshafen am Rhein (DE)

(72) Inventors: Christian WITTENBRINK, Vechta (DE); Falk Soeren NIESTRAT, Buende (DE); Stephan DUBENHORST, Wagenfeld (DE); Moritz ESCH, Osnabrueck (DE)

(73) Assignee: BASE SE, Ludwigshafen am Rhein (DE)

(21) Appl. No.: 15/758,432

(22) PCT Filed: Sep. 7, 2016
(86) PCT No.: PCT/EP2016/071014

§ 371 Date: Mar. 8, 2018

(30) Foreign Application Priority Data
Sep. 15, 2015 (DE) 10 2015 217 605.3

(51) Int. Cl. F16F 1/38; C08K 7/14; C08G 18/08; B29C 65/06; B29C 65/00

(52) U.S. Cl. CPC F16F 1/38; F16F 1/3842; C08K 7/14; C08G 18/14; F16F 9/54; B29C 66/90; F16F 2224/0241; F16F 2226/048; B29C 65/0636

(57) ABSTRACT

The invention relates to a damper bearing comprising a hollow housing (1) for receiving a damping element (5) and a cover (3) for fixing the damping element (5) in the housing (1), wherein the housing (1) and the cover (3) are manufactured from plastic and the connection between the housing (1) and the cover (3) is produced integrally by a welding process, which is based on a relative movement between the housing (1) and the cover (3). The invention furthermore relates to a method for producing a damper bearing according to the invention, in which the housing and the cover are brought into contact at contact surfaces provided for this purpose, and a relative movement between the housing and the cover is then generated, which causes the housing and the cover to be integrally welded as a result of the energy input into the contact surfaces.

The present invention relates to a damper bearing comprising a hollow housing for receiving a damping element and a cover for fixing the damping element in the housing, wherein the housing and the cover are manufactured from plastic.

Damper bearings are used within the running gear of motor vehicles and are well known. Particularly in motor vehicles, they are used as vibration-damping components. In this context, they are used to attach the shock damper to the body and/or to running gear components. By means of flexible coupling of this kind, vibrations caused by the road surface and transmitted via the wheel and shock damper are isolated, as are vibrations caused by the shock damper. The coupling is designed in such a way that cardanic movements of the shock damper are made possible and requirements on force-displacement characteristics in the axial, radial and cardanic directions are met. Depending on the running gear design, axial and radial characteristics have a significant effect on handling and must be precisely tuned. The interaction between the shock damper and the damper bearing has a decisive effect on ride comfort, driving safety, roll and pitch support and on the reduction of the effects of wheel bounce and body shake.

There are various known types of damper bearings, both in respect of the materials used and in respect of production methods. Damper bearings based on diecast aluminum, into which an elastomeric damping element is inserted, are widely used. For production, the damping element is generally inserted into a hollow-cylindrical housing, and the housing is then closed with a cover. Normally, the housing has a collar, into the inside diameter of which the cover is pressed. Here, the collar of the housing is higher than the cover. After the cover has been pressed on, the overlapping region of the collar is folded over by rolling or beading. The cover is thereby fixed firmly in position. The disadvantage with this known method is that the rolling of the edge of the housing limits the forces which can occur during driving. That is to say the strength of the bearing is limited by the strength of the rolled rim. Moreover, “rolling up” of the rim in continuous operation can restrict the durability of the bearing.

As an alternative to securing the cover by rolling or beading, there are known damper bearings in which the cover is connected positively to the housing in some other way, e.g. in the form of a bayonet joint or by screw fastening. As another alternative, integral connections are known, e.g. by welding the cover to the housing. Thus, German Laid-Open Application DE 10 2007 003 207 A1, for example, describes a damper bearing having a housing, a bearing element and a cover, wherein the bearing element is fixed in the housing by the cover. The cover is usually welded to the housing by means of laser welding. DE 103 35 956, DE 10 2007 003 207 A1, DE 102012 001 299 A1 and DE 4321 874 A1 specify different welding techniques for connecting elements of a spring structure.

Often, there is a requirement to arrange the damping element in the damper bearing under precompression in order to ensure certain damping properties. Although precompression of the damping element is possible in principle with all known methods—due to manufacturing tolerances and method-related restrictions among other factors—defined adjustment of the precompression is still difficult and almost impossible to achieve in a precise and reproducible manner.

It is the object to provide damper bearings in which a defined precompression of the damping element can be set and which are nevertheless simple to manufacture and economical to produce.

This object is achieved by damper bearings according to the invention of the kind specified in claim 1. Dependent claims 2 to 7 relate to further advantageous embodiments of the invention. This object is furthermore achieved by a method of the kind indicated in claims 8 to 10.

Damper bearings according to the invention comprise a hollow housing for receiving a damping element and a cover suitable for fixing the damping element in the housing. The housing and the cover are manufactured from plastic. According to the invention, the connection between the housing and the cover is produced integrally by a welding process, which is based on a relative movement between the housing and the cover.

The housing and the cover are welded at contact surfaces provided for this purpose. In a preferred embodiment of the invention, the contact surfaces of the housing and of the cover which are provided for the integral connection are of rotationally symmetrical design. The rotational symmetry is defined by an axis of rotation. The terms “radial” and “axial” below are used with reference to this axis of rotation.

The contact surfaces of the housing and of the cover are preferably spaced apart from the outer surface of the damping element in a radial direction relative to the axis of rotation. This ensures that the plastic mass of the weld seam which forms during welding does not come into direct contact with the damping element, which could have a negative effect on the damping properties. In a development of this preferred embodiment, the contact surfaces are furthermore separated from the outer surface of the damping element by a separating element. Here, the separating element can completely or partially fill the spacing between the damping element and the contact surface.

As a particular preference, the separating element is designed as a groove or web, in particular as an annular groove or annular web. The groove or web can be of continuous or uninterrupted design. In this respect, the term “annular” should not be interpreted as restrictive. The term “separating element”, when used in the singular, should also not be read as being restrictive in this respect. In this embodiment, the radial and axial extent of the groove or of the web should preferably be dimensioned in such a way that the plastic mass of the weld seam which forms during welding can be accommodated at least partially but, especially, completely in the volume defined by the contact surfaces and the groove or web.

The separating element is preferably connected integrally to the housing and/or the cover. For example, it can be part of the injection mold with which the housing or cover are produced.

In another preferred variant of the damper bearing according to the invention, the contact surfaces of the housing and of the cover are conically shaped. In this variant too, a spacing and/or a separating element as described above can be provided.

The housing and the cover can be manufactured from the same plastic or from different plastics. The only prerequisite is that the respective contact surfaces should be able to enter into an integral connection by virtue of a relative movement, this being the case with thermoplastics for example. In respect of material properties such as strength and stiffness, fiber-reinforced plastics materials are preferred. As a particular preference, the housing and the cover are produced on the basis of the same plastics matrix, wherein the fiber content in the housing and in the cover can be the same or different.

In an advantageous embodiment, the housing and the cover are manufactured on the basis of fiber-reinforced polyamide with a fiber content of more than 20%, preferably more than 30%, particularly preferably more than 40%. It should be understood that the fiber content is based on volume.

The damper bearing according to the invention is suitable for receiving at least one damping element in its housing, which element can be fixed in the housing by means of the cover. The damping element can be of single-part or multi-part design and can be based on known materials, such as rubber or polyisocyanate polyaddition products.

In a preferred embodiment, the damping element is based on elastomers on the basis of cellular polyisocyanate polyaddition products, particularly preferably on the basis of cellular polyurethane elastomers, which can contain polyurea structures. Cellular means that the cells preferably have a diameter of 0.01 mm to 0.5 mm, particularly preferably 0.01 mm to 0.15 mm.

As a particular preference, the polyisocyanate polyaddition products have at least one of the following material properties: a density of between 270 and 900 kg/m³ according to DIN EN ISO 845, a tensile strength of ≥2.0 N/mm² according to DIN EN ISO 1798, an elongation at break of ≥200% according to DIN EN ISO 1798 or a tear propagation strength of ≥8 N/mm according to DIN ISO 34-1 B (b). In more preferred embodiments, a polyisocyanate polyaddition product has two, as a further preference three, of these material properties, and particularly preferred embodiments have all four of the material properties mentioned.

Elastomers on the basis of polyisocyanate polyaddition products and the production thereof are well known and described in numerous documents, e.g. in EP 62 835 A1, EP 36 994 A2, EP 250 969 A1, EP 1 171 515 A1, DE 195 48 770 A1 and DE 195 48 771 A1.

In a preferred embodiment of the invention, the housing is designed in such a way that, after welding to the cover, the axial extent of the cavity of the housing amounts to 50% to 95% of the height of the damping element, thus ensuring that the damping element is precompressed. Preferably the amount of precompression chosen is greater, the greater the loading and hence movement in the axial direction of the damping element during use in the vehicle. This ensures that the damping element remains in contact with the interior of the housing and/or of the cover, even in the case of high loads.

In another preferred embodiment, the damping element comprises an insert, which is suitable for securing a piston rod of a shock damper thereon. It is advantageous if the insert is manufactured from metal, e.g. steel or aluminum. It can also be manufactured from a hard plastic, e.g. a fiber-reinforced polyamide.

The damper bearing according to the invention is advantageously used as an axial bearing within the running gear of a motor vehicle. In this case, the piston rod of a shock damper is preferably secured on the insert.

The invention furthermore relates to a method for producing a damper bearing, which comprises a hollow housing for receiving a damping element and a cover for fixing the damping element in the housing, wherein the housing and the cover are manufactured from plastic. In the method according to the invention, the housing and the cover are first of all brought into contact at contact surfaces provided for this purpose. A relative movement between the housing and the cover is then generated, which causes the housing and the cover to be integrally welded as a result of the energy input into the contact surfaces.

Depending on the component geometry, in particular that of the contact surfaces to be brought into contact, different welding methods are preferred, in particular friction welding methods. Whereas, in the case of flat contact surfaces, linear friction welding may also be considered, methods involving rotary friction welding, friction welding involving rotary oscillation or orbital welding, for example, are preferred in the case of rotationally symmetrical contact surfaces.

In another preferred embodiment, oscillating friction welding, preferably friction welding involving linear oscillation, or orbital welding are employed. Here, these welding methods have the advantage that they can also be used with non-rotationally symmetrical geometries of the surfaces to be welded.

An orbital welding method of the kind described in ISO 15620 is preferred. Depending on the embodiment of the components, either single orbital welding, in which only one component oscillates, or multi-orbital friction welding, in which both components to be welded oscillate, is employed. Orbital welding has the advantage that the components to be connected do not have to be rotationally symmetrical. In the case of orbital welding, the axes of the surface to be welded move in the same plane.

In the case of rotationally symmetrical contact surfaces, friction welding involving rotary oscillation or orbital welding is employed as a particular preference, with friction welding involving rotary oscillation being used as a very particular preference.

In another particularly preferred embodiment, the above-described orbital welding method is employed. Particularly in the case of fiber-reinforced components, this has the advantage that the fibers have a relatively low degree of fiber orientation, and this results in better welding.

Since the damping element should normally be preloaded, contact is also made between the cover and the damping element during the welding process. To reduce the probability of possible thermal or mechanical damage to the damping element during welding, particular preference is given to welding methods which cause only slight impingement on the damping element, e.g. friction welding involving rotary oscillation or orbital welding.

In this case, the relative movement of the components to be welded is set in such a way that, although they weld together, the flexibility of the damping element means that the movements which it undergoes are so small that the thermoplastic component is heated to such a small extent that joining does not occur. In this case, the thermal and mechanical damage to the damping element is reduced and, ideally, completely prevented.

In a preferred embodiment of the method according to the invention, the penetration depth of the cover into the cavity of the housing is detected metrologically during the relative movement. In a welding device which holds the housing and the cover in separate tools in order to perform the relative movement, metrological detection can be carried out by detecting a change in the spacing between the tools (travel change) or a change in the forces which have to be exerted, for example.

As a particular preference, the metrologically determined change is used to set a predetermined compression of the damping element. This can be achieved, for example, by detecting the change in the spacing between two tools and adapting the tool contact forces that have to be exerted during the relative movement in such a way that a predetermined penetration depth of the cover into the cavity of the housing is achieved at the end of the welding process. Recourse can be had to known methods for software and/or hardware implementation.

Compared with damper bearings of the kind known from the prior art, damper bearings according to the invention have the advantage, in particular, that the variable welding depth of the cover enables the precompression of the damping element to be set to a defined value. Moreover, the selected methods ensure that the damping element and the attached components do not join together, even in the case of a relatively high preload. The method according to the invention is also suitable for series production, and therefore simple and economical production of the damper bearings in a reproducibly high quality is possible.

### EXAMPLE 1

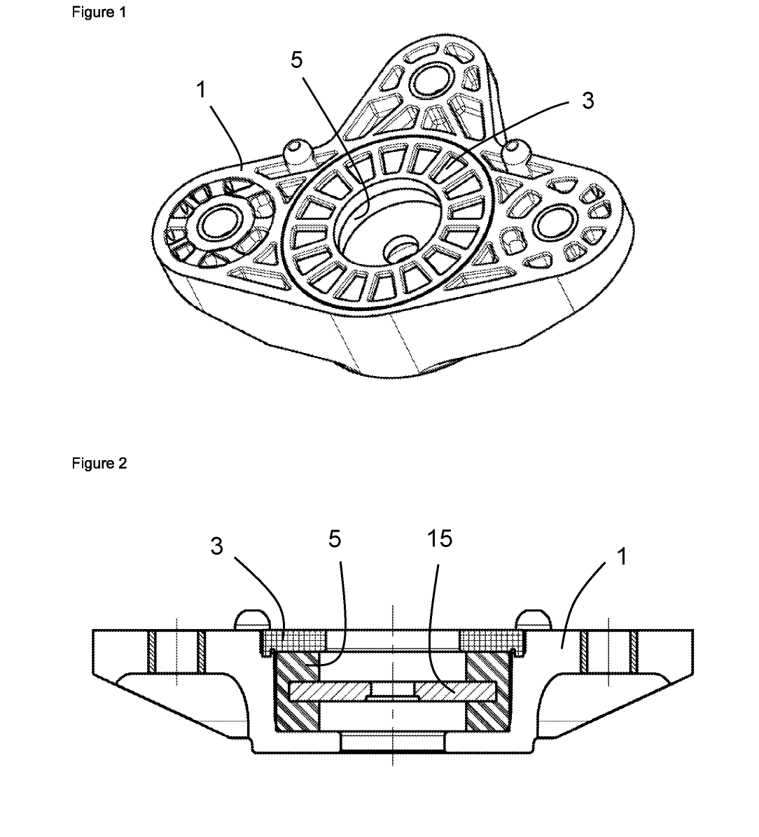

A damper bearing according to the invention is illustrated in a plan view in the fully assembled state in FIG. 1. The damper bearing comprises a housing 1, which is provided for the purpose of being mounted by means of three flanges with through holes on the body of a motor vehicle. In the center of the housing 1, there is a cavity, in which a damping element 5 is accommodated. The damping element 5 is fixed in the cavity of the housing by means of a cover 3. In the example illustrated, the upper side of the cover is flush with the upper side of the housing. However, this embodiment is not compulsory. Depending on the specifications in respect of the installation space in which the damper bearing is to be installed, it is also possible for the upper side of the cover to project beyond the housing or to be inserted into the cavity in a recessed manner.

The housing 1 and the cover 3 are manufactured from plastic, in the example illustrated from polyamide (PA 6.6) with a volume-based glass fiber content to 50%. The connection between the housing and the cover is produced integrally by a welding process, which is based on a relative movement between the housing and the cover.

FIG. 2 shows a longitudinal section through the damper bearing shown in FIG. 1. The damping element 5 is clamped between the housing base and the cover 3. In the example illustrated, the damping element 5 is designed as a hollow cylinder, which has an annular groove centrally in the axial direction, in which an insert 15 is arranged. This insert 15 is used to secure the piston rod of a shock damper thereon.

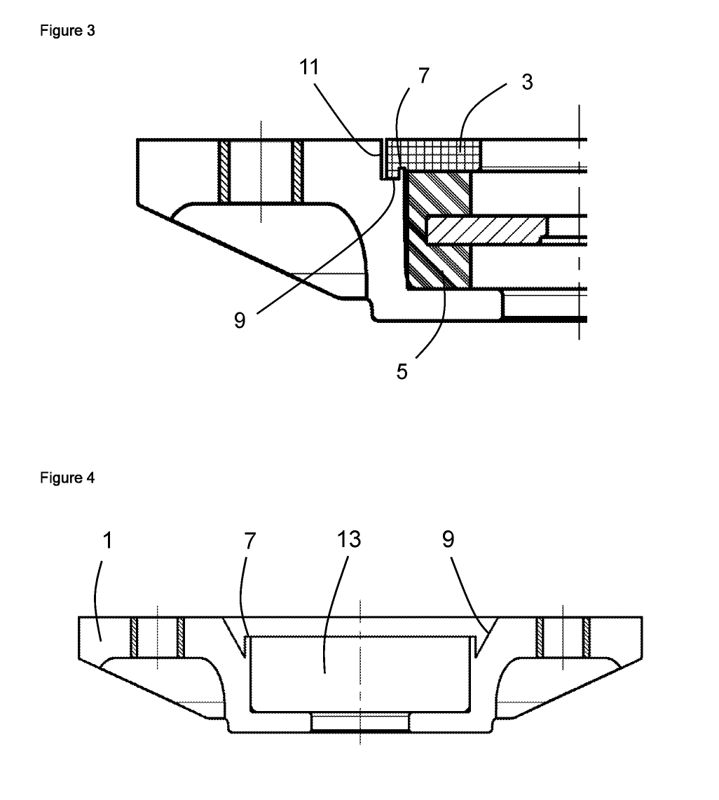

FIG. 3 shows an enlarged detail of the illustration in FIG. 2. In this example, the outside diameter of the cover 3 is smaller than the inside diameter of the housing 1 in the region provided to receive the cover 3. In the assembled state, therefore, an annular gap 11 is formed between the cover 3 and the housing 1. On its lower side, which faces the damping element 5, the cover 3 has an annular groove.

The region of the cover between the groove and its outer rim has a greater thickness than the inner region of the cover. Thus, the rim of the cover projects downward in an axial direction beyond the inner region of the cover. The lower annular surface of this rim forms the contact surface on the cover, which is provided for welding to the housing.

Proceeding outward in a radial direction from the cavity in which the damping element 5 is arranged, the housing 1 first of all has an annular web 7, which is followed by an annular groove. The base of this groove forms the contact surface 9 on the housing, which is provided for welding to the cover.

FIGS. 1 to 3 show the damper bearing in the assembled state. To produce the welded joint, the housing 1 and the cover 3 have been brought into contact at the contact surfaces mentioned, and a relative movement between the housing and the cover has then been generated.

The relative movement causes an energy input in the form of friction into the contact surfaces, which has the effect that the plastics material at the contact surfaces melts and welds integrally.

By virtue of the shaping of the cover and the housing in the region of the groove, the plastics material formed by the melting process remains in the housing and is prevented by the web 7, which acts as a separating element, from coming into contact with the damping element 5. This minimizes and, ideally, completely prevents impairment of the damping element 5 by the welding process.

During the welding process, the cover 3 is pushed in the direction of the housing base. During this process, the extent to which the cover penetrates into the cavity of the housing is detected metrologically. The welding process is continued until a predetermined precompression of the damping element 5 has been achieved.

### EXAMPLE 2

A longitudinal section through a housing 1 of another example of a damper bearing according to the invention is illustrated in FIG. 4. This damper bearing differs from the damper bearing according to example 1 essentially in the shaping of the contact surfaces 9 provided for welding. The contact surfaces of the housing and the cover, which is not shown in FIG. 4, are conically shaped. As in example 1, the contact surface 9 of the housing is separated from the housing cavity 13 provided to receive the damping element by an annular web 7.

For welding, the housing and the cover are brought into contact at the contact surfaces, and a relative movement between the housing and the cover is then generated. The plastics material at the conical contact surfaces melts owing to the energy input and joins together integrally. In comparison with example 1, the surface provided for melting is larger owing to the conical configuration. As in example 1, the damping element is protected from the melting material since it remains in the annular groove formed between the web 7 and the contact surfaces.

1. A damper bearing, comprising
a hollow housing for receiving a damping element and a cover for fixing the damping element in the housing,
wherein the housing and the cover are manufactured from plastic,
wherein a connection between the housing and the cover is produced integrally by orbital welding or oscillating friction welding, which is based on a relative movement between the housing and the cover.

2. The damper bearing of claim 1, wherein contact surfaces of the housing and the cover which are provided for the integral connection are of rotationally symmetrical design.

3. The damper bearing of claim 1, wherein the orbital welding is used.

4. The damper bearing of claim 1, wherein the oscillating friction welding is used.

5. The damper bearing of claim 1, wherein contact surfaces of the housing and the cover are spaced apart from an outer surface of the damping element in a radial direction relative to an axis of rotation and are separated by a separating element.

6. The damper bearing of claim 5, wherein the separating element is designed as a groove or web.

7. The damper bearing of claim 1, wherein contact surfaces of the housing and the cover are conically shaped.

8. The damper bearing of claim 1, wherein the housing and the cover are manufactured of fiber-reinforced polyamide with a fiber content of more than 20%.

9. The damper bearing of claim 1, wherein the damping element is based on a cellular polyisocyanate polyaddition product.

10. A method for producing a damper bearing, the method comprising:
making a hollow housing for receiving a damping element,
making a cover for fixing the damping element in the housing,
contacting the housing with the cover at contact surfaces, and
then generating a relative movement between the housing and the cover, which causes the housing and the cover to be integrally welded as a result of energy input into the contact surfaces,
wherein the housing and the cover are manufactured from plastic.

11. The method of claim 10, wherein a penetration depth of the cover into a cavity of the housing is detected metrologically during the relative movement.

12. The method of claim 11, wherein the metrologically determined penetration depth is used to set a specified compression of the damping elem
